(19) United States
(12) Patent Application Publication
(10) Pub. No.: US 2016/0289424 A1
(43) Pub. Date: Oct. 6, 2016

(54) RESIN COMPOSITION AND RESIN MOLDED ARTICLE

(71) Applicant: FUJI XEROX CO., LTD., Tokyo (JP)

(72) Inventor: Satoshi HAYASAKA, Kanagawa (JP)

(73) Assignee: FUJI XEROX CO., LTD., Tokyo (JP)

(21) Appl. No.: 14/837,830

(22) Filed: Aug. 27, 2015

(30) Foreign Application Priority Data
Mar. 31, 2015 (JP) 2015-071723

(51) Int. Cl. C08K 5/3492; C08K 5/103; C08K 5/11; C08K 5/29; C08K 3/32

(52) U.S. Cl. CPC C08K 5/34922; C08K 5/29; C08K 3/32; C08K 5/11; C08K 5/103; C08K 2003/323

(57) ABSTRACT

A resin composition contains approximately 75 mass % to 95 mass % of a polylactic acid resin relative to the total amount of the resin composition; approximately 2 mass % to 10 mass % of a flame retardant having a structure containing at least one functional group selected from the group consisting of a phosphate group, a sulfate group, and a sulfite group relative to the total amount of the resin composition; approximately 0.1 mass % to 7 mass % of a polyfunctional compound having a carbodiimide group and at least two functional groups relative to the total amount of the resin composition; and approximately 0.1 mass % to 5 mass % of at least one compound selected from a glycerine fatty acid ester and an adipate relative to the total amount of the resin composition.

### CROSS-REFERENCE TO RELATED APPLICATIONS

This application is based on and claims priority under 35 USC 119 from Japanese Patent Application No. 2015-071723 filed Mar. 31, 2015.

### BACKGROUND

(i) Technical Field

The present invention relates to a resin composition and a resin molded article.

(ii) Related Art

Polymeric materials, such as polystyrene, polystyrene-ABS resin copolymers, polycarbonate, polyester, polyphenylene sulfide, and polyacetal, have been typically used in the parts and components of electrical products and electronic or electrical equipment because they have good heat resistance and mechanical strength; particularly in the parts and components of electronic or electrical equipment, such materials have been employed because they well retain mechanical strength on environmental changes.

In recent years, using polylactic-acid-based resin materials instead of the above-mentioned polymeric materials has been studied in view of environmental problems; the polylactic-acid-based resin materials are derived from plants, enable reductions in CO₂ emission and use of oil that is an exhaustible resource, and have a small environmental impact.

### SUMMARY

According to a first aspect of the invention, there is provided a resin composition containing approximately 75 mass % to 95 mass % of a polylactic acid resin relative to the total amount of the resin composition; approximately 2 mass % to 10 mass % of a flame retardant having a structure containing at least one functional group selected from the group consisting of a phosphate group, a sulfate group, and a sulfite group relative to the total amount of the resin composition; approximately 0.1 mass % to 7 mass % of a polyfunctional compound having a carbodiimide group and at least two functional groups relative to the total amount of the resin composition; and approximately 0.1 mass % to 5 mass % of at least one compound selected from a glycerine fatty acid ester and an adipate relative to the total amount of the resin composition.

### DETAILED DESCRIPTION

Exemplary embodiments of the invention will now be described. The exemplary embodiments are examples of the invention, and the invention is not limited thereto.

### Resin Composition

A resin composition according to a first exemplary embodiment contains a (A) polylactic acid resin; a (B) flame retardant having a structure containing at least one functional group selected from the group consisting of a phosphate group, a sulfate group, and a sulfite group; a (C) hydrolysis inhibitor that is a polyfunctional compound having a carbodiimide group and at least two functional groups; and a (D) plasticizer that is at least one compound selected from a glycerine fatty acid ester and an adipate.

In the resin composition according to the first exemplary embodiment, the amount of the (A) polylactic acid resin is in the range of approximately 75 mass % to 95 mass % relative to the total amount of the resin composition; the amount of the (B) flame retardant having a structure containing at least one functional group selected from the group consisting of a phosphate group, a sulfate group, and a sulfite group is in the range of approximately 2 mass % to 10 mass % relative thereto; the amount of the (C) polyfunctional compound having a carbodiimide group and at least two functional groups is in the range of approximately 0.1 mass % to 7 mass % relative thereto; and the amount of the (D) at least one compound selected from a glycerine fatty acid ester and an adipate is in the range of approximately 0.1 mass % to 5 mass % relative thereto.

In the resin composition according to the first exemplary embodiment, the (B) flame retardant is used in combination with the other materials (A), (C), and (D) in an amount of approximately 2 mass % to 10 mass % relative to the total amount of the resin composition, so that the resin composition may be shaped into an article that has a flame retardancy and is less likely to suffer from bleeding (bleed out). Controlling the drip properties of a molded article (viscosity of the resin on burning) may contribute to maintaining high flame retardancy of V-2 or more in a resin material primarily containing about 75 mass % or more of a polylactic acid resin and also reducing bleeding, which is caused by a flame retardant, to an unexpectedly high extent for such material composition, which has been hard to be achieved by existing techniques; in addition, generation of burrs (protrusions) may be reduced in molding at high temperature. The cause thereof has been still studied, but the high flame retardancy is presumed to be as follows: not only quenching by a phosphorus or sulfuric acid attributed to the flame retardant used but also an increase in viscosity due to combining the (A) polylactic acid resin, the (B) flame retardant, and the (C) hydrolysis inhibitor and a decrease in viscosity due to the (D) plasticizer results in the melt viscosity being adjusted in burning; and thus dripping has become easy to occur in the burning. Furthermore, ammonium polyphosphate and melamine nitrate as the (B) flame retardant foam on burning, and it is presumed that a foam insulation layer is therefore formed inside the resin to block the heat of flame and also to facilitate dripping in the burning. It is believed that the reduction in generation of burrs is owing to the above-mentioned increased viscosity and that the reduction in the occurrence of bleeding results from adjusting the amount of the flame retardant to be small. In the case where the amount of the (B) flame retardant exceeds the above-mentioned amount, such an amount of the flame retardant may bring about bleeding. In the case where the amounts of the additives other than the polylactic acid resin are excess, the content percentage of the plant-derived component is low, which results in an enhancement in an environmental impact.

In production of a molded article of the resin composition according to the first exemplary embodiment, the optimum melt viscosity in burning has been still studied; it is believed that melt viscosity measured with a thrust-type rheometer is ideally in the range of 2000 Pa/s to 7000 Pa/s (180° C., 1 Hz, and 1%).

### (A) Polylactic Acid Resin

The resin composition according to the first exemplary embodiment contains a polylactic acid resin as a resin component. The polylactic acid resin is plant-derived and contributes to a reduction in an environmental impact; in particular, it enables reductions in CO₂ emission and use of exhaustible resources such as oil. Any kind of polylactic acid resin may be used provided that it is a condensation product of a lactic acid; the polylactic acid resin may be a poly-L-lactic acid (hereinafter referred to as “PLLA”); a poly-D-lactic acid (hereinafter referred to as “PDLA”); a material in which these polylactic acids have been mixed, such as a copolymer or a blend; or a stereocomplex-type polylactic acid (hereinafter referred to as “SC-PLA”) in which PLLA and PDLA have been mixed and in which the helical structures thereof are entangled with each other to give high heat resistance.

The component ratio of PLLA to PDLA (percentage based on a molar ratio) in a copolymer or mixture thereof is not particularly limited; since crystallinity and heat resistance are high when the purity of an enantiomer is high, the ratio of L-lactic acid/D-lactic acid is preferably in the range of 50/50 to 99.99/0.01. If the ratio of L-lactic acid/D-lactic acid is less than 50/50, a molded article has a low mechanical strength; if the ratio is greater than 99.99/0.01, production costs tend to increase.

The polylactic acid resin to be used may be either a synthesized one or a commercially available one. Examples of commercially available polylactic acid resins include TERRAMAC TE4000, TERRAMAC TE2000, and TERRAMAC TE7000 manufactured by UNITIKA. LTD.; Ingeo 3251D, Ingeo 3001D, and Ingeo 4032D manufactured by NatureWorks LLC; and REVODE 110 and REVODE 190 manufactured by ZHEJIANG HISUN BIOMATERIALS CO., LTD. Polylactic acid resins may be used alone or in combination.

The polylactic acid resin may contain a plant-derived copolymerization component other than a lactic acid, such as ethylene glycol or dibutanol. The amount of such a copolymerization component is generally from 1 mol % to 50 mol % in all of the monomer components. The polylactic acid resin to be used may be modified, and examples thereof include a maleic-anhydride-modified polylactic acid, an epoxy-modified polylactic acid, and an amine-modified polylactic acid.

In the resin composition according to the first exemplary embodiment, the amount of the (A) polylactic acid resin ranges from approximately 75 mass % to 95 mass %, and preferably approximately 85 mass % to 95 mass % relative to the total amount of the resin composition. At the (A) polylactic acid resin content of less than 75 mass % relative to the total amount of the resin composition, the plant-derived component content is insufficient, which leads to an increased environmental impact; at the (A) polylactic acid resin content of greater than 95 mass % relative thereto, the flame retardancy is less likely to be given to the resin composition, and burrs are likely to be generated.

The molecular weight of the polylactic acid resin is not particularly limited; in the first exemplary embodiment, the weight average molecular weight of the polylactic acid resin ranges preferably from 8,000 to 200,000, and more preferably from 15,000 to 120,000. In the case where the polylactic acid resin has a weight average molecular weight of less than 8,000, the resin composition has a high burning rate, and a molded article of such a resin composition tends to have a low mechanical strength at low temperature. In the case where the polylactic acid resin has a weight average molecular weight of greater than 200,000, a molded article of such a resin composition tends to have a decreased flexibility and decreased flame retardancy.

The weight average molecular weight of the polylactic acid resin in the resin composition refers to a weight average molecular weight determined as follows: the resin composition is cooled in a liquid nitrogen atmosphere, a test sample is scraped from the surface thereof and then dissolved in deuterated chloroform at a concentration of 0.1 mass %, and the weight average molecular weight of a separated polylactic acid is measured by gel permeation chromatography. In the measurement by gel permeation chromatography, HLC-8220GPC manufactured by TOSOH CORPORATION is used.

### (B) Flame Retardant

The resin composition according to the first exemplary embodiment contains the flame retardant that is a compound having a structure containing at least one functional group selected from the group consisting of a phosphate group, a sulfate group, and a sulfite group. The (B) flame retardant gives the resin flame retardancy; and a functional group in its structure, such as a phosphate group, a sulfate group, and a sulfite group, is bonded to a carbodiimide group contained in the hydrolysis inhibitor. The (B) flame retardant used in the first exemplary embodiment is, for example, a flame retardant that is a solid at 200° C. A solid flame retardant having a structure containing a phosphate group as a functional group is, for instance, ammonium polyphosphate; and examples thereof include Exolit AP422 (trade name, manufactured by Clariant GmbH), Exolit AP462 (trade name, manufactured by Clariant GmbH), FR CROS 484 (trade name, manufactured by Budenheim Ibérica), and Terraju S10 (trade name, manufactured by Chisso Corporation). Another solid flame retardant having a structure containing a phosphate group as a functional group is, for instance, melamine polyphosphate; and an example thereof is MPP-A (trade name, manufactured by SANWA Chemical Co., Ltd).

Exolit AP422 (trade name) is ammonium polyphosphate that is represented by the formula (NH₄PO₃)n (where n is from 200 to 1000), in the form of free-flowing powder, and less soluble in water. Exolit AP462 (trade name) is a microcapsule formed by encapsulating Exolit AP422 with a melamine resin. FR CROS 484 (trade name) is ammonium polyphosphate (form II) having a volume average particle size (d50) of 18 μm; the ammonium polyphosphate (form II) is a high-molecular-weight ammonium polyphosphate having multiple cross-linking points and branching with a degree of polymerization of not less than 1000 and has both high decomposition temperature and low water solubility. Terraju S10 (trade name) is the above-mentioned ammonium polyphosphate (form II).

Examples of a solid flame retardant having a structure containing a sulfate group as a functional group include melamine sulfate such as Apinon 901 (trade name, manufactured by SANWA Chemical Co., Ltd), guanidine sulfate, sulfuric acid, ethylamine sulfate, and pyridine sulfate.

Examples of a solid flame retardant having a structure containing a sulfite group as a functional group include amine-sulfite-based compounds.

The (B) flame retardants may be used alone or in combination.

In the resin composition according to the first exemplary embodiment, the amount of the (B) flame retardant is in the range of approximately 2 mass % to 10 mass %, and preferably approximately 5 mass % to 10 mass % relative to the total amount of the resin composition. At the (B) flame retardant content of less than 2 mass % relative to the total amount of the resin composition, a molded article of the resin composition has a reduced flame retardancy. At the (B) flame retardant content of greater than 10 mass % relative to the total amount of the resin composition, bleeding is highly likely to occur in a molded article of the resin composition; in addition, since the content percentage of the polylactic acid resin is small, the plant-derived component content is insufficient, which leads to an increased environmental impact.

### (C) Hydrolysis Inhibitor

The resin composition according to the first exemplary embodiment contains the hydrolysis inhibitor that is a polyfunctional compound having a carbodiimide group and at least two functional groups. Hydrolysis inhibitors are generally used for suppressing decomposition of an ester bond of the polylactic acid resin and for end capping; however, the (C) hydrolysis inhibitor used in the first exemplary embodiment serves as a binder for bonding a carboxylic acid group of the polylactic acid resin to a functional group of the flame retardant, such as a phosphate group, a sulfate group, or a sulfite group, via a carbodiimide group, and it is believed that the hydrolysis inhibitor contributes to an enhancement in the melt viscosity of a molded article of the resin composition. The molecules of the polyfunctional compound used in the first exemplary embodiment each have a carbodiimide group represented by —N═C═N—, and the polyfunctional compound has at least two functional groups that react with the terminal groups of the (A) polylactic acid resin (e.g., carboxyl group or hydroxyl group) and the above-mentioned functional groups of the (B) flame retardant.

Examples of the polyfunctional compound having functional groups that react with the terminal groups of the polylactic acid resin include dicarbodiimide compounds and polycarbodiimide compounds. Examples of the dicarbodiimide compounds include aliphatic dicarbodiimide and aromatic dicarbodiimide.

The above-mentioned dicarbodiimide compounds and polycarbodiimide compounds may be used alone or in combination. Other examples of the dicarbodiimide compounds include N,N′-diisopropylcarbodiimide and N,N′-dicyclohexylcarbodiimide. Examples of commercially available dicarbodiimide compounds and polycarbodiimide compounds include Stabaxol 1-LF (trade name, manufactured by Rhein Chemie Corporation), CARBODILITE HMV-8CA, and CARBODILITE LA1 (trade names, manufactured by Nisshinbo Chemical Inc.). Stabaxol 1-LF is N,N′-di-2,6-diisopropylphenylcarbodiimide, CARBODILITE HMV-8CA is a polycarbodiimide of which materials include hydrogenated methylene diphenyl diisocyanate, and CARBODILITE LA1 is poly(4,4′-dicyclohexylmethane carbodiimide) that is a polyfunctional compound.

The amount of the (C) polyfunctional compound containing a carbodiimide group in the first exemplary embodiment is from approximately 0.1 mass % to 7 mass %, and preferably approximately 0.3 mass % to 5 mass % relative to the total amount of the resin composition. In the case where the amount of the (C) polyfunctional compound containing a carbodiimide group is less than 0.1 mass % relative to the total amount of the resin composition, a molded article of the resin composition has a reduced flame retardancy. In the case where the amount of the (C) polyfunctional compound containing a carbodiimide group is greater than 7 mass % relative to the total amount of the resin composition, the flowability of the resin composition is degraded with the result that the resin composition becomes hard to be shaped; in addition, since the content percentage of the polylactic acid resin is small, the plant-derived component content is insufficient, which leads to an increased environmental impact.

### (D) Plasticizer

The resin composition according to the first exemplary embodiment contains a plasticizer that is at least one compound selected from a glycerine fatty acid ester and an adipate. It is believed that the (D) plasticizer gives the polylactic acid resin plasticity to enable decreasing the melt viscosity of the resin on burning and facilitating quenching by a drip. The excessive amount of the (D) plasticizer, however, may lead to generation of bleeding and burrs. The glycerine fatty acid ester may be a diglycerine fatty acid ester in terms of a reduction in generation of burrs.

A diglycerine fatty acid ester is an ester of diglycerine and a fatty acid. Examples of the fatty acid include fatty acids such as caproic acid, caprylic acid, pelargonic acid, capric acid, lauric acid, myristic acid, palmitic acid, stearic acid, oleic acid, linolic acid, linoleic acid, arachic acid, arachidonic acid, icosapentaenoic acid, gadoleic acid, behenic acid, erucic acid, lignoceric acid, selacholeic acid, cerotic acid, montanoic acid, melissic acid, ceroplastic acid, ricinoleic acid, and 12-hydroxystearic acid. Mixed fatty acids containing these fatty acids and derived from natural fats and oils may be used. Examples of the natural fats and oils include vegetable oils, such as linseed oil, perilla oil, oiticica oil, olive oil, cacao-seed oil, kapok oil, white mustard oil, sesame oil, rice bran oil, safflower oil, shea nut oil, Chinese wood oil, soybean oil, camellia sinensis seed oil, camellia oil, corn oil, rapeseed oil, palm oil, palm kernel oil, castor oil, sunflower oil, cottonseed oil, coconut oil, Japan wax, and peanut oil, and animal oils and fats, such as horse fat, beef tallow, neat's foot oil, ghee, lard, goat tallow, mutton tallow, milk fat, fish oil, and whale oil. Fatty acids having 6 to 22 carbon atoms or mixed fatty acids containing fatty acids having 6 to 22 carbon atoms and derived from natural fats and oils may be employed in terms of compatibility. The esterification degree of the polyglycerine fatty acid ester, namely, the percentage of the number of hydroxyl groups subjected to esterification in glycerine to the number of hydroxyl groups therein before the esterification is not particularly limited, but it is desirable that all of the hydroxyl groups be not subjected to the esterification.

Adipate is an ester of adipic acid and alcohol. Examples of the alcohol include oxo alcohol, isononyl alcohol, and isodecyl alcohol.

The plasticizers described above may be used alone or in combination. Examples of the diglycerine fatty acid esters include RIKEMAL S-74 and RIKEMAL S-71-D (trade names, manufactured by RIKEN VITAMIN Co., Ltd.). An example of the adipate is DAIFATTY 101 (trade name, manufactured by DAIHACHI CHEMICAL INDUSTRY CO., LTD.).

The amount of the (D) plasticizer in the first exemplary embodiment is from approximately 0.1 mass % to 5 mass %, and preferably approximately 0.3 mass % to 3 mass % relative to the total amount of the resin composition. In the case where the amount of the (D) plasticizer is less than 0.1 mass % relative to the total amount of the resin composition, a molded article of the resin composition has a reduced flame retardancy. In the case where the amount of the (D) plasticizer is greater than 5 mass % relative to the total amount of the resin composition, a molded article of the resin composition has a reduced flame retardancy, bleeding occurs, and burrs are likely to be generated in molding at high temperature; in addition, since the content percentage of the polylactic acid resin is small, the plant-derived component content is insufficient, which leads to an increased environmental impact.

### (E) Crystal Nucleating Agent

The resin composition according to the first exemplary embodiment may contain a crystal nucleating agent. The crystal nucleating agent to be used may be general crystal nucleating agents used for polymers without limitation, and either an inorganic or organic crystal nucleating agent may be used. Specific examples of the inorganic crystal nucleating agent include talc, kaolinite, montmorillonite, synthetic mica, clay, zeolite, silica, graphite, carbon black, zinc oxide, magnesium oxide, titanium oxide, calcium sulfide, boron nitride, calcium carbonate, barium sulfate, aluminum oxide, neodymium oxide, and metal salts of phenylphosphonate. These inorganic crystal nucleating agents can be modified with an organic substance so that they can have high dispersibility in the composition.

Specific examples of the organic crystal nucleating agent include organic metal carboxylates such as sodium benzoate, potassium benzoate, lithium benzoate, calcium benzoate, magnesium benzoate, barium benzoate, lithium terephthalate, sodium terephthalate, potassium terephthalate, calcium oxalate, sodium laurate, potassium laurate, sodium myristate, potassium myristate, calcium myristate, sodium octacosanoate, calcium octacosanoate, sodium stearate, potassium stearate, lithium stearate, calcium stearate, magnesium stearate, barium stearate, sodium montanate, calcium monotanoate, sodium toluate, sodium salicylate, potassium salicylate, zinc salicylate, aluminum dibenzoate, potassium dibenzoate, lithium dibenzoate, sodium β-naphthalate, and sodium cyclohexane carboxylate; organic sulfonates such as sodium p-toluene sulfonate and sodium sulfoisophthalate; carboxylic acid amides such as stearic amide, ethylenebislauric amide, palmitic amide, hydroxystearic amide, erucic amide, and trimesic tris(t-butylamide); benzylidene sorbitol and derivatives thereof; phosphorous compound metal salts such as sodium-2,2′-methylene bis(4,6-di-t-butylphenyl)phosphate; and sodium 2,2-methyl bis(4,6-di-butylphenyl).

Among the above examples, the crystal nucleating agent used in the first exemplary embodiment is particularly preferably at least one selected from talc, organic metal carboxylates, and carboxylic acid amides. These crystal nucleating agents may be used alone or in combination. A crystal nucleating agent in which 1 part by mass of clay has been preliminarily added to 100 parts by mass of polylactic acid, such as TERRAMAC TE7000 manufactured by UNITIKA LTD., may be employed. Furthermore, ECOPROMOTE manufactured by Nissan Chemical Industries, Ltd., which is a crystal nucleating agent for polylactic acid, may be employed.

In the first exemplary embodiment, the amount of the (E) crystal nucleating agent is preferably in the range of 0.1 mass % to 10 mass %, and more preferably 0.5 mass % to 2 mass % relative to the total amount of the resin composition.

### Rubber and Thermoplastic Elastomer

The resin composition according to the first exemplary embodiment may contain at least one of rubber and a thermoplastic elastomer. Examples of the rubber and thermoplastic elastomer usable in the first exemplary embodiment include silicone/acrylic composite rubber, acrylic rubber, butadiene rubber, and natural rubber. In particular, core-shell rubber has a double structure consisting of the core and the shell; the core is a soft rubber, the shell on the surface thereof is a hard resin, and the core-shell rubber itself is an elastic body that is in the form of powder (particle). Even after the core-shell rubber is, for example, melt-kneaded with the polylactic acid resin, the original particle state of most of the particles has not been changed. Since most of the rubber particles used retains the initial form, they are well dispersible in the polylactic acid resin composition, and the surface layers thereof are not easily peeled.

Examples of commercially available core-shell rubbers include METABLEN SX-005, METABLEN SRK200, METABLEN W600A, and METABLEN C-223A (trade names, manufactured by MITSUBISHI RAYON CO., LTD.); MR-01 and MR-02 (trade names, manufactured by KANEKA CORPORATION); PARALOID EXL-2603 (trade name, manufactured by KUREHA CORPORATION); HiBlen B621 (trade name, manufactured by ZEON CORPORATION); and PARALOID KM330 (trade name, manufactured by Rohm and Haas Company).

Each of METABLEN SX-005, METABLEN SRK200, METABLEN S-2001, and METABLEN C-223A manufactured by MITSUBISHI RAYON CO., LTD., for instance, has a core-shell structure in which a graft layer is formed outside rubber that is in the form of particles. In each of METABLEN SRK200 and METABLEN S-2001, the core is butadiene rubber, and the graft layer is any of polycarbonate (PC), polybutylene terephthalate (PBT), polyamide (PA), polyethylene terephthalate (PET), polystyrene (PS), polyvinyl chloride (PVC), an ABS resin (ABS), and an acrylic resin (MMA). In METABLEN SX-005, the core is the same as described above, and the material of the graft layer further includes polypropylene (PP) and polyethylene (PE). In METABLEN C-223A, the core is silicone/acrylic composite rubber, and the graft layer is any of PC, PBT, PA, PS, and PVC.

The amount of the rubber/thermoplastic elastomer in the first exemplary embodiment is preferably in the range of 1 mass % to 20 mass %, and more preferably 5 mass % to 15 mass % relative to the total amount of the resin composition.

### Other Components

The resin composition of the first exemplary embodiment may further contain an antioxidant, a stabilizer, an ultraviolet absorber, an anti-drip agent, and other flame retardants.

Examples of the antioxidant include phenol, amine, phosphorus, sulfur, hydroquinone, and quinoline antioxidants. These antioxidants may be used alone or in combination.

Examples of the stabilizer include nitrogen-containing compounds such as basic-nitrogen-containing compounds, e.g., polyamide, poly-β-alanine copolymers, polyacrylamide, polyurethane, melamine, cyanoguanidine, and melamine-formaldehyde condensates; alkali-containing or alkaline-earth-metal-containing compounds such as organic metal carboxylates (e.g., a calcium stearate and calcium 12-hydroxystearate), metal oxides (e.g., magnesium oxide, calcium oxide, and aluminum oxide), metal hydroxides (e.g., magnesium hydroxide, calcium hydroxide, and aluminum hydroxide), and metal carbonates; zeolites; and hydrotalcites. These stabilizers may be used alone or in combination.

Examples of the ultraviolet absorber include benzophenones, benzotriazoles, cyanoacrylates, salicylates, and anilide oxalates. These ultraviolet absorbers may be used alone or in combination.

The resin composition according to the first exemplary embodiment may include other flame retardants as long as the impact resistance thereof is not impaired. Examples of such other flame retardants include silicone flame retardants, nitrogen flame retardants, and inorganic hydroxide flame retardants. These flame retardants may be used alone or in combination.

Other flame retardants to be used may be either synthesized products or commercially available products. An example of commercially available silicone flame retardants is DC4-7081 manufactured by Dow Corning Toray Co., Ltd. Examples of commercially available nitrogen flame retardants include melamine pyrophosphate manufactured by Shimonoseki Mitsui Chemicals, Inc. and FP2100 manufactured by ADEKA Corporation. Examples of commercially available inorganic hydroxide flame retardants include MGZ300 manufactured by SAKAI CHEMICAL INDUSTRY CO., LTD. and B103ST manufactured by Nippon Light Metal Company, Ltd.

Use of an anti-drip agent leads to an enhancement in the anti-drip properties (resistance to melt dripping) of a molded article of the resin composition. In the resin composition according to the first exemplary embodiment, use of an anti-drip agent therefore results in an easy decrease in flame retardancy; hence, use of an anti-drip agent is properly eliminated. An example of the anti-drip agent is polytetrafluoroethylene, and examples of polytetrafluoroethylene include Fluon PTFE fine powder manufactured by ASAHI GLASS CO., LTD. (Fluon is registered trademark) and M-111 manufactured by DAIKIN INDUSTRIES, LTD. Fluon PTFE fine powder includes a CD1 series that includes polymers of a low reduction ratio (low RR) and a CD0 series that includes copolymers of a high reduction ratio (high RR). These anti-drip agents may be used alone or in combination.

The resin composition according to the first exemplary embodiment may contain resin other than the polylactic acid resin, a mold releasing agent, a weathering agent, a light stabilizer, and a colorant.

### Measurement

The amount of each of the (A) polylactic acid resin; the (B) flame retardant having a structure containing at least one functional group selected from the group consisting of a phosphate group, a sulfate group, and a sulfite group; the (C) polyfunctional compound having a carbodiimide group and at least two functional groups; and the (D) at least one compound selected from a glycerine fatty acid ester and an adipate in the resin composition can be determined by ¹H-NMR analysis. The amounts of impurities, such as a lactone contained in the polylactic acid in the resin composition, can be also determined in the same manner. The amount of each of the (A) polylactic acid resin; the (B) flame retardant having a structure containing at least one functional group selected from the group consisting of a phosphate group, a sulfate group, and a sulfite group; the (C) polyfunctional compound having a carbodiimide group and at least two functional groups; and the (D) at least one compound selected from a glycerine fatty acid ester and an adipate in a resin molded article produced by using the resin composition can be determined by ¹H-NMR analysis. From the amount of each component in the resin molded article, which is determined in this manner, the amount thereof in the resin composition is estimated.

The weight average molecular weight of the polylactic acid resin in the resin composition is determined by dissolving a polymer in a solvent and using the solution in size exclusion chromatography (GPC). In particular, the polylactic acid resin is dissolved in tetrahydrofuran (THF) and analyzed by molecular weight distribution measurement (GPC). The weight average molecular weight of the polylactic acid resin in a resin molded article produced by using the resin composition is determined by dissolving a polymer in a solvent and using the solution in size exclusion chromatography (GPC). Specifically, the polylactic acid resin is dissolved in tetrahydrofuran (THF) and analyzed by molecular weight distribution measurement (GPC).

The glass transition temperature of the polylactic acid resin in the resin composition is measured in accordance with JIS K 7121 with a thermal analyzer (DSC6000 type, manufactured by SII NanoTechnology Inc.). The glass transition temperature of the polylactic acid resin in the resin molded article produced by using the resin composition is measured in accordance with JIS K 7121 with a thermal analyzer (DSC6000 type, manufactured by SII NanoTechnology Inc.).

In the resin composition and the rein molded article produced by using the resin composition, the amounts of the other additives are determined by analyses of the structure and composition ratio of each of the materials with an elemental analyzer, a nuclear magnetic resonance (NMR) apparatus, an infrared radiation (IR) apparatus, or another apparatus. In addition, the amounts of the other additives in the resin composition are presumed from the amounts thereof in the resin molded article.

### Production of Resin Composition

The resin composition according to the first exemplary embodiment may be produced, for example, by kneading the (A) polylactic acid resin; the (B) flame retardant having a structure containing at least one functional group selected from the group consisting of a phosphate group, a sulfate group, and a sulfite group; the (C) polyfunctional compound having a carbodiimide group and at least two functional groups; the (D) at least one compound selected from a glycerine fatty acid ester and an adipate in the molded article of the resin composition; optionally the (E) crystal nucleating agent; and further optionally other components.

Kneading may be, for example, performed with existing kneaders such as a twin-screw kneader (e.g., TEM58SS manufactured by TOSHIBA MACHINE CO., LTD.) and a simple kneader (e.g., LABO PLASTOMILL manufactured by Toyo Seiki Seisaku-sho, Ltd.). The temperature for the kneading (cylinder temperature) is less than the decomposition temperature of the polylactic acid resin; for example, it is preferably in the range of 150° C. to 220° C., and more preferably 160° C. to 200° C.

### Resin Molded Article

The resin molded article according to a second exemplary embodiment can be produced by, for instance, molding the resin composition according to the first exemplary embodiment.

The resin molded article according to the second exemplary embodiment is produced, for example, by a molding technique such as injection molding, extrusion molding, blow molding, or heat press molding. The resin molded article produced by injection molding of the resin composition according to the first exemplary embodiment can be employed for the reason of, for instance, productivity.

The injection molding may be, for example, performed with a commercially available apparatus such as NEX150 manufactured by NISSEI PLASTIC INDUSTRIAL CO., LTD.; NEX70000 manufactured by NISSEI PLASTIC INDUSTRIAL CO., LTD., Ltd.; or SE50D manufactured by TOSHIBA MACHINE CO., LTD. The cylinder temperature in this procedure is preferably in the range of 160° C. to 240° C., and more preferably 170° C. to 210° C. in order to, for example, suppress decomposition of the polylactic acid resin. The die temperature is preferably in the range of from 30° C. to 120° C., and more preferably 30° C. to 60° C. in consideration of, for instance, productivity.

The resin molded article according to the second exemplary embodiment has a flame retardancy and is less likely to suffer from the occurrence of bleeding.

### Parts and Components of Electronic or Electrical Equipment

Since the resin molded article according to the second exemplary embodiment can be excellent in mechanical strength (e.g., impact resistance and tensile elasticity), it is suitably used for applications such as electronic or electrical equipment, household appliances, containers, and interior materials used in automobile. More specifically, the resin molded article according to the second exemplary embodiment is useful for the housings and various parts and components of household appliances or electronic or electrical equipment, wrapping films, storage cases of CD-ROMs or DVDs, tableware, food trays, bottles for drink, and drug wrapping materials. In particular, the resin molded article according to the second exemplary embodiment is suitable for the parts and components of electronic or electrical equipment. Many of the parts and components of electronic or electrical equipment have complicated shapes and are heavy weights; thus, they are expected to have a high impact resistance as compared with the case where the weight is not heavy. The resin molded article according to the second exemplary embodiment sufficiently satisfies such a requirement. The resin molded article according to the second exemplary embodiment is especially suitable for the housings of, for example, image forming apparatuses and copiers.

### EXAMPLES

Exemplary embodiments of the invention will now be specifically described with reference to Examples and Comparative Examples but are not limited thereto.

### Examples, Comparative Examples, and Reference Examples

Materials are prepared in amounts (parts by mass) shown in Table 1, put in a twin-screw kneader (TEM58SS manufactured by TOSHIBA MACHINE CO., LTD.), kneaded at a cylinder temperature of 180° C. to produce resin compositions (compounds). Then, each of these resin compositions is put into an injection molding apparatus (NEX-50 manufactured by NISSEI PLASTIC INDUSTRIAL CO., LTD.) and subjected to injection molding at a resin temperature of 190° C. and a molding temperature of 100° C. to produce a test sample having a size of a 50-mm square and a thickness of 2 mm. Table 2 shows the trade name and supplier of each of the components shown in Table 1.

### Measurement and Evaluation

The test sample is subjected to measurement and evaluation described below. Table 1 shows results thereof.

### Test of Flame Retardancy

A UL test sample (thickness: 1.6 mm) for the V test of UL-94 is used, and a UL-V test is performed in accordance with UL-94. In results of the UL-V test, the flame retardancy is highest in V-0, lower in V-1 than in V-0, and lower in V-2 than in V-1. The flame retardancy is lower in NotV than in V-2. A test sample having a flame retardancy of V-2 or higher is regarded as being successful. Table 1 shows results of the test.

### Evaluation of Burrs

Burrs (protrusions) generated at the parting line of a test sample are observed visually or with a microscope (VH-500 manufactured by KEYENCE CORPORATION). The evaluation is based on the following criteria, and a test sample with a result of “C” or higher is regarded as being successful. Table 1 shows results of the evaluation.
A: No burr observed
B: Burr observed with a microscope, but not visually observed
C: Burr visually observed, but no problem with product quality
D: Non-negligible burr observed, problematic with product quality

### Evaluation of Bleeding

A test sample is put into a high-temperature and high-humidity bath (THN042PA manufactured by Toyo Seiki Seisaku-sho, Ltd.) at 60° C. and 90% RH, and generation of bleeding (bleed out) after the lapse of the following predetermined time is visually observed. The evaluation is based on the following criteria, and a test sample with a result of “C” or higher is regarded as being successful. Table 1 shows results of the evaluation.
A: No bleeding observed in a test sample exposed to high temperature and high humidity for 1500 hours
B: No bleeding observed in a test sample exposed to high temperature and high humidity for 1000 hours
C: No bleeding observed in a test sample exposed to high temperature and high humidity for 500 hours
D: Bleeding observed in a test sample exposed to high temperature and high humidity for 500 hours

### Plant-Derived Component Content

The plant-derived component content shown in Table 1 is the content percentage of a plant-derived material relative to the total amount of the resin composition; in this case, it is the content percentage of the polylactic acid resin relative to the total amount of the resin composition.

TABLE 1

| | Polylactic | | Flame | | | | | |
|---|---|---|---|---|---|---|---|---|
| | acid resin | | retardant | | Hydrolysis | | Plasticized | |
| | (A) | Mass % | (B) | Mass % | inhibitor (C) | Mass % | (D) | Mass % |
| Example 1 | A1 | 94.5 | B1 | 3 | C1 | 2 | D1 | 0.5 |
| Example 2 | A1 | 76 | B1 | 10 | C2 | 7 | D2 | 5 |
| Example 3 | A2 | 93.5 | B3 | 4 | C3 | 0.5 | D1 | 2 |
| Example 4 | A4 | 89 | B4 | 5 | C1 | 2 | D1 | 3 |
| Example 5 | A3 | 95.1 | B2 | 3 | C1 | 1.5 | D3 | 0.4 |
| Example 6 | A2 | 92 | B3 | 2 | C1 | 4 | D1 | 2 |
| Example 7 | A2 | 94.9 | B4 | 3 | C3 | 0.1 | D2 | 2 |
| Comparative | A1 | 95.5 | B3 | 3 | C1 | 1 | — | 0 |
| Example 1 | | | | | | | | |
| Comparative | A4 | 94 | 0 | — | C2 | 3 | D3 | 3 |
| Example 2 | | | | | | | | |
| Comparative | A3 | 78 | B1 | 9 | C3 | 1 | D2 | 12 |
| Example 3 | | | | | | | | |
| Comparative | A2 | 91.2 | B3 | 3.6 | — | 0 | D1 | 5 |
| Example 4 | | | | | | | | |
| Comparative | A4 | 71 | B1 | 15 | C2 | 7 | D1 | 7 |
| Example 5 | | | | | | | | |
| Comparative | A1 | 85 | B1 | 1 | C2 | 7 | D2 | 5 |
| Example 6 | | | | | | | | |
| Comparative | A1 | 91.95 | B2 | 3 | C1 | 0.05 | D2 | 5 |
| Example 7 | | | | | | | | |
| Comparative | A3 | 95.45 | B3 | 2 | C3 | 0.5 | D3 | 0.05 |
| Example 8 | | | | | | | | |
| Reference | A4 | 81.5 | B1 | 10 | C1 | 5 | D2 | 1 |
| Example 1 | | | | | | | | |
| Reference | A1 | 89.5 | B2 | 5 | C2 | 0.5 | D1 | 4 |
| Example 2 | | | | | | | | |

| | | | Anti- | | Plant- | | | |
|---|---|---|---|---|---|---|---|---|
| | Crystal | | drip | | derived | | | |
| | nucleating | | agent | | component | Flame | | |
| | agent (E) | Mass % | (F) | Mass % | content | retardancy | Burrs | Bleeding |
| Example 1 | — | 0 | — | 0 | 94.5 | V-2 | A | A |
| Example 2 | E1 | 2 | — | 0 | 76 | V-2 | B | C |
| Example 3 | — | 0 | — | 0 | 93.5 | V-2 | B | B |
| Example 4 | E2 | 1 | — | 0 | 89 | V-2 | B | B |
| Example 5 | — | 0 | — | 0 | 95.1 | V-2 | B | A |
| Example 6 | — | 0 | — | 0 | 92 | V-2 | B | A |
| Example 7 | — | 0 | — | 0 | 94.9 | V-2 | C | A |
| Comparative | E1 | 0.5 | — | 0 | 95.5 | NotV | A | B |
| Example 1 | | | | | | | | |
| Comparative | — | 0 | — | 0 | 94 | NotV | C | A |
| Example 2 | | | | | | | | |
| Comparative | — | 0 | — | 0 | 78 | NotV | D | D |
| Example 3 | | | | | | | | |
| Comparative | E1 | 0.2 | — | 0 | 91.2 | NotV | C | C |
| Example 4 | | | | | | | | |
| Comparative | — | 0 | — | 0 | 71 | V-2 | B | D |
| Example 5 | | | | | | | | |
| Comparative | E1 | 2 | — | 0 | 85 | NotV | B | B |
| Example 6 | | | | | | | | |
| Comparative | — | 0 | — | 0 | 91.95 | NotV | C | C |
| Example 7 | | | | | | | | |
| Comparative | E1 | 2 | — | 0 | 95 | NotV | C | A |
| Example 8 | | | | | | | | |
| Reference | E2 | 2 | F1 | 0.5 | 81.5 | NotV | A | B |
| Example 1 | | | | | | | | |
| Reference | — | 0 | F1 | 1 | 89.5 | NotV | A | B |
| Example 2 | | | | | | | | |

TABLE 2

| Components | Signs | Trade names or compound names | Suppliers | Remarks |
|---|---|---|---|---|
| Polylactic acid resin | A1 | Ingeo 4032D | NatureWorks LLC | |
| | A2 | Ingeo 3100HP | NatureWorks LLC | |
| | A3 | REVODE 110 | ZHEJIANG HISUN BIOMATERIALS CO., LTD. | |
| | A4 | REVODE 190 | ZHEJIANG HISUN BIOMATERIALS CO., LTD. | |
| Flame retardant | B1 | Apinon 901 | SANWA Chemical Co., Ltd | Melamine sulfate |
| | B2 | MPP-A | SANWA Chemical Co., Ltd | Melamine polyphosphate |
| | B3 | Exolit AP422 | Clariant GmbH | Ammonium polyphosphate |
| | B4 | FR CROS 484 | Budenheim lberica | Ammonium polyphosphate |
| Hydrolysis inhibitor | C1 | CARBODILITE HMV-8CA | Nisshinbo Chemical Inc. | Polycarbodiimide |
| | C2 | CARBODILITE LA1 | Nisshinbo Chemical Inc. | Dicarbodiimide |
| | C3 | Stabaxol 1-LF | Rhein Chemie Corporation | Dicarbodiimide |
| Plasticizer | D1 | RIKEMAL S-74 | RIKEN VITAMIN Co., Ltd. | Diglycerine fatty acid ester |
| | D2 | RIKEMAL S-71-D | RIKEN VITAMIN Co., Ltd. | Diglycerine fatty acid ester |
| | D3 | DAIFATTY 101 | DAIHACHI CHEMICAL INDUSTRY CO., LTD. | Adipate |
| Crystal nucleating agent | E1 | ECOPROMOTE | Nissan Chemical Industries, Ltd. | |
| | E2 | Talc | NIPPON TALC Co., Ltd. | |
| Anti-drip agent | F1 | M-111 | DAIKIN INDUSTRIES, LTD. | PTFE |

The molded articles in Examples retain flame retardancy while the occurrence of bleeding is reduced, as compared with the molded articles in Comparative Examples.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A resin composition comprising:
approximately 75 mass % to 95 mass % of a polylactic acid resin relative to the total amount of the resin composition;
approximately 2 mass % to 10 mass % of a flame retardant having a structure containing at least one functional group selected from the group consisting of a phosphate group, a sulfate group, and a sulfite group relative to the total amount of the resin composition;
approximately 0.1 mass % to 7 mass % of a polyfunctional compound having a carbodiimide group and at least two functional groups relative to the total amount of the resin composition; and
approximately 0.1 mass % to 5 mass % of at least one compound selected from a glycerine fatty acid ester and an adipate relative to the total amount of the resin composition.

2. A resin molded article produced by using the resin composition according to claim 1.
